(19) United States
(12) Patent Application Publication
(10) Pub. No.: US 2007/0273629 A1
(43) Pub. Date: Nov. 29, 2007

(54) Display drive circuit and drive method for the same

(76) Inventors: Bily Wang, Hsin Chu City (TW); John Lin, Chia I Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/438,426

(22) Filed: May 23, 2006

(51) Int. Cl. G09G 3/36

(52) U.S. Cl. 345/92

(57) ABSTRACT

A display drive circuit and a drive method for the same are proposed. The drive circuit is alternately controlled by a first control signal and a second control signal in each frame time, and alternately performs storage or release of image data to a first maintaining capacitor and a second maintaining capacitor in an LCD panel according to scan signals. Frames stored in the first maintaining capacitor and the second maintaining capacitor in the LCD panel can therefore be continuously and alternately output for display.

### BACKGROUND OF THE INVENTION

1. Field of the Invention

The present invention relates to a display drive circuit and a drive method for the same and, more particularly, to a drive circuit and a drive method using thin-film transistors as synchronous drive components.

2. Description of Related Art

FIG. 1 is an equivalent circuit diagram of a prior art thin film transistor LCD panel and its peripheral drive circuit. As shown in FIG. 1, crisscrossing data electrodes (Y1, Y2 . . . Ym) and scan electrodes (X1, X2 . . . Xn) are formed on an LCD panel 1. Each set of crisscrossing data electrode and scan electrode can be used to control a display device D. For instance, the data electrode Y1 and the scan electrode X1 can be used to control a display device D1. Each display device D is controlled by a set of crisscrossing data and scan electrodes via a drive circuit. The equivalent circuit of each drive circuit is formed by connecting a thin film transistor Q for controlling entry of data and a storage capacitor C.

The gate and drain of the thin film transistor Q are connected to a scan electrode and a data electrode, respectively. A scan signal on a scan electrode can conduct or cut off all thin film transistors Q in the same row, that is, the same scan line, thereby controlling whether a video signal on the data electrode can be written to a corresponding display device D.

Reference is made to FIG. 2 as well as FIG. 1. FIG. 2 shows waveforms of scan signals in the prior art. A scan drive unit 12 outputs scan signals (S1, S2 . . . Sn) to the scan electrodes (X1, X2 . . . Xn) based on a predetermined scanning order. When some scan electrode has a scan signal thereon, all the thin film transistors Q in the drive circuits in the same row or on the same scan electrode conduct, while the thin film transistors Q in other rows are cut off. When some scan electrode is selected, a data drive unit 10 will send out a corresponding video signal, a gray-level value, to m display devices of that row based on the image data to be displayed.

When the scan drive unit 12 finishes one scanning action on all n rows of scan lines, the display action of a frame is complete. Repetitively scanning all the scan electrodes (X1, X2 . . . Xn) and sending out the video signal of image data can accomplish the object of continuously displaying an image.

The display action of a frame of the prior art LCD panel 1 is controlled by the scan signals (S1, S2 . . . Sn). This kind of drive control technology, however, usually cannot effectively finish the display action of the LCD panel 1 owing to the changing and discharge transient characteristics of the thin film transistor and the storage capacitor of each drive circuit. Therefore, frame retention during frame crossover will occur, affecting the display quality of the LCD panel 1.

### SUMMARY OF THE INVENTION

An object of the present invention is to provide a display drive circuit and a drive method for the same, in which thin film transistors are used as synchronous drive components. The drive circuit of the present invention is used in an LCD panel. The drive circuit comprises a first maintaining capacitor and a second maintaining capacitor. Each drive circuit of the LCD panel is controlled by a first control signal. Image data of a frame are temporarily stored into the first maintaining capacitor in a frame time based on scan signals, while image data of the previous frame originally stored in the second maintaining capacitor are synchronously transferred to a display unit, thereby accomplishing synchronous display actions of the LCD panel

In the next frame time, each drive circuit of the LCD panel is controlled by a second control signal. Image data of the next frame are temporarily stored into the second maintaining capacitor in a frame time based on scan signals, while image data of the previous frame originally stored in the first maintaining capacitor are synchronously transferred to the display unit, thereby accomplishing synchronous display actions of the LCD panel. In this way, frames respectively stored in the first and second maintaining capacitors can be continuously and alternately output for display.

To achieve the above objects, the present invention provides a drive circuit comprising a transistor controlled by a scan signal to capture a data signal. A first charging transistor is connected to the transistor and a first maintaining capacitor, and is controlled by a first control signal to obtain the data signal and store the data signal in the first maintaining capacitor. A second charging transistor is connected to the transistor and a second maintaining capacitor , and is controlled by a second control signal to obtain the data signal and store the data signal in the second maintaining capacitor. A first discharge transistor is connected to the first maintaining capacitor and the display device and is controlled by the second control signal to transfer the data signal stored in the first maintaining capacitor to the display device. A second discharge transistor is connected to the second maintaining capacitor and the display device, and is controlled by the first control signal to transfer the data signal stored in the second maintaining capacitor to the display device.

The drive circuit is alternately controlled by the first control signal and the second control signal every frame time, and performs storage or release of image data to the first maintaining capacitor and the second maintaining capacitor in an LCD panel according to scan signals. Through alternate control of the first and second control signals, frames respectively stored in the first and second maintaining capacitors in the LCD panel can be continuously and alternately output for display. Therefore, the present invention can solve the problem of frame retention during frame crossover owing to the charging and discharge transient characteristics of the thin film transistor and the storage capacitor.

### BRIEF DESCRIPTION OF THE DRAWINGS

The various objects and advantages of the present invention will be more readily understood from the following detailed description when read in conjunction with the appended drawing, in which:

FIG. 1 is an equivalent circuit diagram of a prior at thin film transistor LCD panel and its peripheral drive circuit;

FIG. 2 shows waveforms of scan signals in the prior art;

FIG. 3 is an equivalent circuit diagram of an LCD panel and a peripheral drive circuit thereof according to the present invention;

FIG. 4 is a circuit diagram of a drive circuit of the present invention; and

FIG. 5 shows waveforms of scan signals and control signals of the present invention.

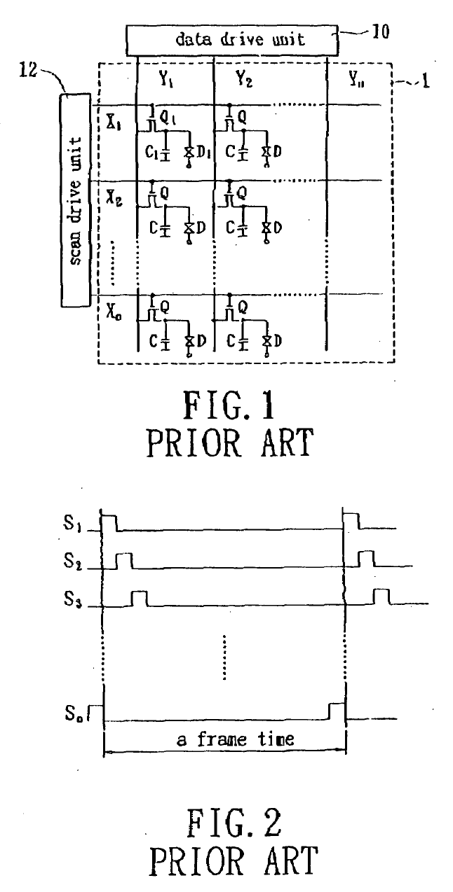

### DETAILED DESCRIPTION OF THE PREFERRED EMBODIMENTS

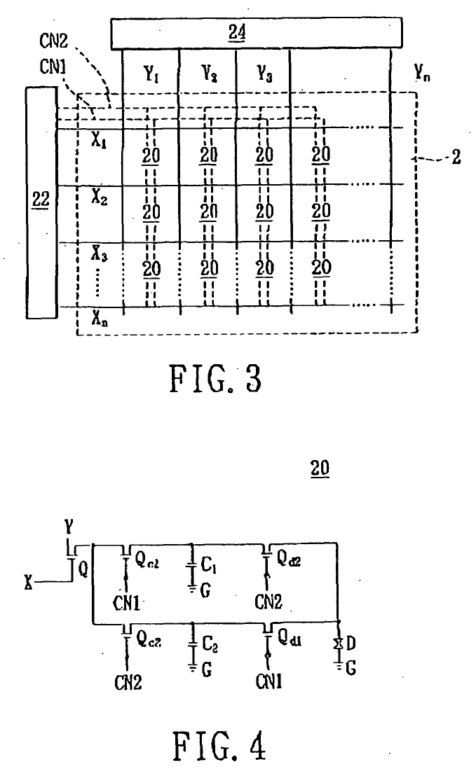

FIG. 3 is an equivalent circuit diagram of an LCD panel and a peripheral drive circuit thereof according to the present invention. The present invention applies to an LCD panel 2 with crisscrossing data electrodes (Y1, Y2 . . . Ym). Scan electrodes (X1, X2 . . . Xn) are formed thereon. The data electrodes (Y1, Y2 . . . Ym) are correspondingly connected to outputs of a data drive unit 24, while scan electrodes (X1, X2 . . . Xn) are correspondingly connected to outputs of a scan drive unit 22. Each set of crisscrossing data electrode and scan electrode can be used to control a display unit 20 according to the output of the scan drive unit 22 and the output of the data drive unit 24.

Reference is made to FIG. 4 as well as FIG. 3. Each display unit 20 of the LCD panel 2 uses the drive circuit of the present invention to drive a display device D. The display device D is a liquid crystal display (LCD). The drive circuit of the present invention comprises a transistor Q. The transistor Q is a thin film transistor (TFT). The gate of the transistor Q is connected to an output of the scan drive unit 22 via a scan electrode X to receive a scan signal. The drain of the transistor Q is connected to an output of the data drive unit 24 via a data electrode Y to obtain a data signal.

The source of the transistor Q is connected to a first charging transistor Qc1 and a second charging transistor Qc2. The first charging transistor Qc1 is also connected to a first maintaining capacitor C1, obtains the data signal according to the conduction state of the transistor Q, and is controlled by a first control signal CN1 to store the data signal to the first maintaining capacitor C1. The second changing transistor Qc2 is also connected to a second maintaining capacitor C2, obtains the data signal according to the conduction state of the transistor Q, and is controlled by a second control signal CN2 to store the data signal in the second maintaining capacitor C2. A first discharge transistor Qd1 is connected to the first maintaining capacitor C1 and the display device D, and is controlled by the second control signal CN2 to transfer the data signal stored in the first maintaining capacitor C1 to the display device D. A second discharge transistor Qd2 is connected to the second maintaining capacitor C2 and the display device D, and is controlled by the first control signal CN1 to transfer the data signal stored in the second maintaining capacitor C2 in the display device D.

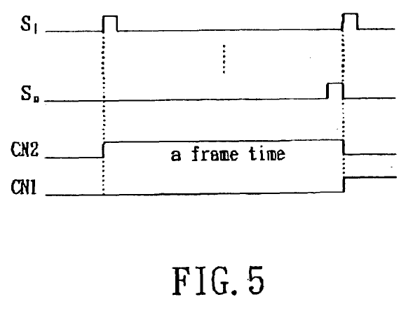

Reference is made to FIG. 5 as well as FIGS. 3 and 4. Scan signals (S1, S2 . . . Sn) are sent out by the scan drive unit 22. The scan signals (S1, S2 . . . Sn) are periodically sent to each display unit 20 via the scan electrodes (X1, X2 . . . Xn) of the LCD panel 2 according to a predetermined scan order. In each period of the scan signals (S1, S2 . . . Sn), the scan drive unit 22 also periodically sends out the first control signal CN1 and the second control signals CN2 to each display unit 22 to complete synchronous display actions of the LCD panel 2.

When a scan electrode (X1, X2 . . . Xn) receives a scan signal, the transistors Q in all the display units 20 in the same row or on the same scan electrode conduct, while the transistors Q in the other rows are cut off. When the first control signal CN1 is high, the first charging transistor Qc1 in each display unit 20 conducts. Because the transistor Q in each display unit 20 also conducts, the data signal output b the data drive unit 24 will first be temporarily stored in the first maintaining capacitors C1 in all the display units 20 in the same row or on the same scan electrode.

The scan signals (S1, S2 . . . Sn) sent out by the scan drive unit 22 are periodically transferred to all the display units 20 in the same row or on the same scan electrode on the LCD panel 2 via the scan electrodes (X1, X2 . . . Xn) in a predetermined scan order. When the first control signal CN1 is high in a frame time, the data signal output by the data drive unit 24 will first be temporarily stored in the first maintaining capacitors C1 in all the display units 20 on the LCD panel 2. This is the image data of a frame.

At the same time, when the first control signal CN1 is high in a frame time, the first control signal CN1 simultaneously turns the first discharge transistor Qd1 on. The image data of a frame already stored in the second maintaining capacitors C2 in all the display units 20 will be output to the display device D for image display.

When the second control signal CN2 alternately rises to a high level after the first control signal CN1 and the first control signal CN1 drops to a low level, the second charge transistors Qc2 in all the display units 20 will be controlled to be on. Because the transistors Q in all the display unit 20 are on, the data signal output by the data drive unit 24 will first be temporarily stored in the second maintaining capacitors C2 in all the display units 20 in the same row or on the same scan electrode.

The scan signals (S1, S2 . . . Sn) sent out by the scan drive unit 22 are periodically transferred to all the display units 20 in the same row or on the same scan electrode on the LCD panel 2 via the scan electrodes (X1, X2 . . . Xn) in a predetermined scan order. When the second control signal CN2 is high in a frame time, the data signal output by the data drive unit 24 will first be temporarily stored in the second maintaining capacitors C2 in all the display units 20 on the LCD panel 2. This is the image data of a frame.

At the same time, when the second control signal CN2 is high in a frame time, the second control signal CN2 simultaneously turns the second discharge transistor Qd2 on. The image data of a frame already stored in the first maintaining capacitors C1 in all the display units 20 will be output to the display device D doe image display.

The drive circuit of the present invention is alternately controlled by the first control signal CN1 and the second control signal CN2 every frame time, and performs storage or release of image data to the first maintaining capacitor C1 and the second maintaining capacitor C2 in the LCD panel according to scan signals. Through alternate control of the first and second control signals, frames respectively stored in the first maintaining capacitor C1 and the second maintaining capacitor C2 in the LCD panel can be continuously and alternately output for display. Therefore, the present invention can solve the problem of frame retention during frame crossover owing to the charging and discharge transient characteristics of the thin film transistor and the storage capacitor.

A display drive method of the present invention comprises the steps of: sequentially turning a transistor in each display unit on to obtain a frame's data; sequentially storing the frame's data to a first maintaining capacitor in each display unit; and synchronously transferring a previous frame's data stored in a second maintaining capacitor in each display unit to a display device. After the step of synchronous transfer, the transistors are sequentially turned on to obtain the next frame's data, the next frame's data is sequentially stored in the second maintaining capacitor in each display unit, and the frame's data stored in the first maintaining capacitor in each display unit is synchronously transferring to the display device. In this way, frames respectively stored in the first and second maintaining capacitors can be continuously output for display.

The present invention also provides a display drive method comprising the steps of: storing a frame's data into a first maintaining capacitor in each display unit; and synchronously transferring a previous frame's data stored in a second maintaining capacitor in each display unit to a display device. After synchronous transfer, the next frame's data is stored in the second maintaining capacitor in each display unit, and the frame's data stored in the first maintaining capacitor in each display unit is synchronously transferred to the display device. Through alternate control of the first and second control signals, frames respectively stored in the first and second maintaining capacitors in the LCD panel can be continuously output for display. Therefore, the present invention can solve the problem of frame retention during frame crossover owing to the charging and discharge transient characteristics of the thin film transistor and the storage capacitor.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A display drive circuit for driving a display device, comprising:
a transistor controller by a scan signal to capture a data signal;
a first charging transistor connected to said transistor and a first maintaining capacitor and controlled by a first control signal to obtain said data signal and store said data signal into said first maintaining capacitor;
a second charging transistor connected to said transistor and a second maintaining capacitor and controlled by a second control signal to obtain said data signal and store said data signal in said second maintaining capacitor;
a first discharge transistor connected to said first maintaining capacitor and said display device and controlled by said second control signal to transfer said data signal stored in said first maintaining capacitor to said display device; and
a second discharge transistor connected to said second maintaining capacitor and said display device and controlled by said first control signal to transfer said data signal stored in said second maintaining capacitor to said display device.

2. The display drive circuit as claimed in claim 1, wherein said transistor is a thin film transistor.

3. The display drive circuit as claimed in claim 1, wherein all said first charging transistor, said second charging transistor, said first discharge transistor, and said second discharge transistor are thin film transistors.

4. The display drive circuit as claimed in claim 1, wherein said drive circuit is alternately controlled by said first control signal and said second control signal in each frame time, and alternately performs storage or release of image data to said first maintaining capacitor and said second maintaining capacitor in an LCD panel according to said scan signal.

5. A drive method of a display having a plurality of display units, said drive method comprising the steps of:
sequentially turning a transistor in each of said display units on to obtain a frame's data;
sequentially storing said frame's data in a first maintaining capacitor in each of said display units; and
synchronously transferring a previous frame's data stored in a second maintaining capacitor in each of said display units to each display device.

6. The drive method as claimed in claim 5 further comprising the following steps after said step of synchronous transfer:
sequentially turning said transistor on to obtain a next frame's data;
sequentially storing said next frame's data in said second maintaining capacitor in each of said display units; and
synchronously transferring said frame's data stored in said first maintaining capacitor in each of said display units to each display device.

7. A drive method of a display having a plurality of display units, said drive method comprising the steps of:
storing a frame's data into a first maintaining capacitor in each of said display units; and
synchronously transferring a previous frame's data stored in a second maintaining capacitor in each of said display units to each display device.

8. The drive method as claimed in claim 7 further comprising the following steps after said step of synchronous transfer:
storing the next frame's data into said second maintaining capacitor in each of said display units; and
synchronously transferring said frame's data stored in said first maintaining capacitor in each of said display units to each display device.
